(19) United States
(12) Patent Application Publication
(10) Pub. No.: US 2023/0100420 A1
(43) Pub. Date: Mar. 30, 2023

(54) NONAQUEOUS ELECTROLYTE ENERGY STORAGE DEVICE

(71) Applicant: GS Yuasa International Ltd., Kyoto-shi, Kyoto (JP)

(72) Inventors: Kazuki KAWAGUCHI, Kyoto (JP); Keiji SHIMOMURA, Kyoto (JP); Masashi TAKANO, Kyoto (JP); Kenta UEHIRA, Kyoto (JP)

(21) Appl. No.: 17/910,014

(22) PCT Filed: Mar. 10, 2021
(86) PCT No.: PCT/JP2021/009404

§ 371 Date: Sep. 8, 2022

(30) Foreign Application Priority Data
Mar. 12, 2020 (JP) 2020-043398

(51) Int. Cl. H01M 4/133

(52) U.S. Cl. CPC H01M 4/133; H01M 2004/027

(57) ABSTRACT

A nonaqueous electrolyte energy storage device according to one aspect of the present invention is a nonaqueous electrolyte energy storage device including: a negative electrode including a negative electrode material layer; and a nonaqueous electrolyte containing an unsaturated cyclic carbonate, in which the negative electrode material layer contains a solid graphite particle with an aspect ratio of 1 or more and 5 or less, and the amount of substance of the unsaturated cyclic carbonate with respect to a surface area of the negative active material layer is 0.03 mmol/m² or more and 0.08 mmol/m² or less.

### TECHNICAL FIELD

The present invention relates to a nonaqueous electrolyte energy storage device.

### BACKGROUND ART

A nonaqueous electrolyte secondary battery typified by a lithium ion nonaqueous electrolyte secondary battery is widely in use for electronic equipment such as personal computers and communication terminals, automobiles and the like because the battery has high energy density. The nonaqueous electrolyte secondary battery is generally provided with an electrode assembly having a pair of electrodes electrically isolated by a separator, and a nonaqueous electrolyte interposed between the electrodes and is configured for charge-discharge by transferring ions between both the electrodes. Also, a capacitor such as lithium ion capacitor and electric double-layer capacitor is also widely used as a nonaqueous electrolyte energy storage device other than a nonaqueous electrolyte secondary battery.

As a typical form of the nonaqueous electrolyte energy storage device, a nonaqueous electrolyte energy storage device having electrodes (positive electrode and negative electrode) in which an active material layer containing an active material are laminated on an electrode substrate is widely used. As a negative active material, a carbon material such as graphite is widely used (see Patent Document 1).

### PRIOR ART DOCUMENTS

### Patent Documents

Patent Document 1: JP-A-2005-222933

### SUMMARY OF THE INVENTION

### Problems to be Solved by the Invention

One of requirements for the nonaqueous electrolyte energy storage device is high durability, and high performance is maintained over a long period of time. In a conventional nonaqueous electrolyte energy storage device including a negative electrode containing graphite as a negative active material, improvement is desired in terms of durability such as deterioration of power characteristics with long-term use.

The present invention has been made in view of the above circumstances, and an object of the present invention is to provide a nonaqueous electrolyte energy storage device including a negative electrode containing graphite and having high power characteristics even after long-term use.

### Means for Solving the Problems

A nonaqueous electrolyte energy storage device according to one aspect of the present invention is a nonaqueous electrolyte energy storage device including; a negative electrode including a negative electrode material layer; and a nonaqueous electrolyte containing an unsaturated cyclic carbonate, in which the negative electrode material layer contains a solid graphite particle with an aspect ratio of 1 or more and 5 or less, and the amount of substance of the unsaturated cyclic carbonate with respect to a surface area of the negative active material layer is 0.03 mmol/m² or more and 0.08 mmol/m² or less.

### Advantages of the Invention

According to one aspect of the present invention, it is possible to provide a nonaqueous electrolyte energy storage device including a negative electrode containing graphite and having high power characteristics even after long-term use.

### BRIEF DESCRIPTION OF THE DRAWINGS

FIG. 1 is a schematic perspective view illustrating an energy storage device (nonaqueous electrolyte energy storage device) in one embodiment of the present invention.

FIG. 2 is a schematic view illustrating an energy storage apparatus configured by assembling a plurality of energy storage devices (nonaqueous electrolyte energy storage devices) in one embodiment of the present invention.

FIG. 3 is a graph showing evaluation results of nonaqueous electrolyte energy storage devices of Example and Comparative Example using graphite particle A (solid graphite particle) or graphite particle B (hollow graphite particle).

### MODE FOR CARRYING OUT THE INVENTION

First, an outline of a nonaqueous electrolyte energy storage device disclosed in the present specification will be described.

A nonaqueous electrolyte energy storage device according to one aspect of the present invention is a nonaqueous electrolyte energy storage device including: a negative electrode including a negative electrode material layer; and a nonaqueous electrolyte containing an unsaturated cyclic carbonate, in which the negative electrode material layer contains a solid graphite particle with an aspect ratio of 1 or more and 5 or less, and the amount of substance of the unsaturated cyclic carbonate with respect to a surface area of the negative active material layer is 0.03 mmol/m² or more and 0.08 mmol/m² or less.

The nonaqueous electrolyte energy storage device according to one aspect of the present invention is a nonaqueous electrolyte energy storage device including a negative electrode containing graphite, and has high power characteristics even after long-term use. The reason for this is not clear, but is presumed as follows. Conventionally, many graphite particles used as a negative active material have a hollow shape or a high aspect ratio, and have a high degree of exposure of an edge surface. To the nonaqueous electrolyte of the nonaqueous electrolyte energy storage device, an unsaturated cyclic carbonate such as vinylene carbonate, which is decomposed during charge to form a film on the particle surface of the negative active material, may be added in order to improve durability and the like. When a graphite particle with a high degree of exposure of the edge surface is used, the consumption amount due to continuous decomposition of the unsaturated cyclic carbonate associated with long-term use is large. Therefore, in order to sufficiently cover the edge surface of the graphite particle to suppress deterioration of power characteristics after long-term use, it is necessary to increase the addition amount of the unsaturated cyclic carbonate. However, when the addition amount of the unsaturated cyclic carbonate is large, a film thicker than necessary is locally formed on the edge surface of the graphite particle at the time of initial charge-discharge, or a thick film is easily formed on a portion other than the edge surface, so that the power characteristics may be deteriorated immediately after the initial charge-discharge. For these reasons, when a conventional general graphite particle is used, it is difficult to increase the power characteristics after long-term use even if the addition amount of the unsaturated cyclic carbonate is adjusted. On the other hand, the graphite particle used in the nonaqueous electrolyte energy storage device according to one aspect of the present invention has a low aspect ratio, a solid shape, and a low degree of exposure of the edge surface. When such a graphite particle is used, even a relatively small amount of the unsaturated cyclic carbonate to be added can form a film capable of sufficiently covering the edge surface of the graphite particle, and the consumption amount due to continuous decomposition of the unsaturated cyclic carbonate associated with long-term use is also small. That is, it is presumed that in the nonaqueous electrolyte energy storage device according to one aspect of the present invention, the solid graphite particle with a low aspect ratio is used, and the amount of the unsaturated cyclic carbonate present in the nonaqueous electrolyte is in an appropriate range that is not excessive with respect to the surface area of the negative active material layer, so that the film derived from the unsaturated cyclic carbonate is in a state of being formed with an appropriate thickness and high uniformity on the entire surface of the solid graphite particle. From the above, it is presumed that the nonaqueous electrolyte energy storage device according to one aspect of the present invention has high power characteristics even after long-term use.

The term “graphite” refers to a carbon material in which an average lattice spacing (d₀₀₂) of a (002) plane determined by an X-ray diffraction method before charge-discharge or in a discharged state is 0.33 nm or more and less than 0.34 nm. Here, the “discharged state” refers to a state where an open circuit voltage is 0.7 V or more in a unipolar battery using a negative electrode, containing a carbon material as a negative active material as a working electrode and using metallic Li as a counter electrode. Since the potential of the metallic Li counter electrode in an open circuit state is substantially equal to an oxidation/reduction potential of Li, the open circuit voltage in the unipolar battery is substantially equal to the potential of the negative electrode containing the carbon material with respect to the oxidation/redaction potential of Li. That is, the fact that the open circuit voltage in the unipolar battery is 0.7 V or more means that lithium ions that can be occluded and released in association with charge-discharge are sufficiently released from the carbon material that is the negative active material.

In addition, being “solid” in the solid graphite particle means that the inside of the particle is dense and has substantially no void. More specifically being “solid” means that in a cross section of a particle observed in a SEM image acquired by a scanning electron microscope (SEM), the area ratio excluding voids in the particle relative to the total area of the particle is 95% or more. In one preferred aspect, the area ratio of the solid graphite particle can be 97% or more (e.g. 99% or more).

The area ratio of the graphite particle excluding voids in the particle relative to the total area of the particle can be determined in accordance with the following procedure.

### (1) Preparation of Sample for Measurement

The powder of the graphite particle to be measured is fixed with a thermosetting resin. A cross-section polisher is used to expose the cross section of the graphite particle fixed with resin to produce a sample for measurement.

### (2) Acquisition of SEM Image

For acquiring the SEM image, JSM-7001F (manufactured by JEOL Ltd.) is used as a scanning electron microscope. As the SEM image, a secondary electron image is observed. An acceleration voltage is 15 kV. An observation magnification is set so that the number of graphite particles appearing in one field of view is 3 or more and 15 or less. The obtained SEM image is stored as an image file. In addition, various conditions such as spot diameter, working distance, irradiation current, luminance, and focus are appropriately set so as to make the contour of the graphite particle clear.

### (3) Cut-Out of Contour of Graphite Particle

The contour of the graphite particle is cut out from the acquired SEM image by using an image cutting function of an image editing software Adobe Photoshop Elements 11. The contour is cut out by using a quick selection tool to select the outside of the contour of the graphite particle and edit a portion except for the graphite particle to a black background. At this time, when the number of the graphite particles from which the contours have been able to be cut out is less than three, the SEM image is acquired again, and the cutout is performed until the number of the graphite particles from which the contours have been able to be cut out becomes three or more.

### (4) Binarization Processing

The image of the first graphite particle among the cut-out graphite particles is binarized by using image analysis software PopImaging 6.00 to set to a threshold value a concentration 20% lower than a concentration at which the intensity becomes maximum. By the binarization processing, an area on the low-concentration side is calculated to obtain “an area S1 excluding voids in the particle”.

Next, the image of the first graphite particle is binarized using a concentration 10 as a threshold value. The outer edge of the graphite particle is determined by the binarization processing, and the area inside the outer edge is calculated to obtain an “area S0 of the whole particle”.

By calculating a ratio of S1 relative to S0 (S1/S0) by using S1 and S1 calculated above, “an area ratio T1 excluding voids in the particle relative to the total area of the particle” in the first graphite particle is calculated.

The images of the second and subsequent graphite particles among the cut-out graphite particles are also subjected to the binarization processing described above, and the areas S1 and S0 are calculated. Based on the calculated area S1 and area S0, area ratios T2, T3, . . . of the respective graphite particles are calculated.

### (5) Determination of Area Ratio

By calculating the average value of all the area ratios T1, T2, T3, . . . calculated by the binarization processing, “the area ratio of the graphite particle excluding voids in the particle relative to the total area of the particle” is determined.

The “aspect ratio” means the A/B value that is the ratio of the longest diameter A of the particle to the longest diameter B in the direction perpendicular to the diameter Ain the cross section of the particle observed in the SEM image by the scanning electron microscope. The aspect ratio can be determined as follows.

### (1) Preparation of Sample for Measurement

A sample for measurement having an exposed cross section used for determining the area ratio described above is used.

### (2) Acquisition of SEM Image

For acquiring the SEM image, JSM-7001F (manufactured by JEOL Lt is used as a scanning electron microscope. As the SEM image, a secondary electron image is observed. An acceleration voltage is 15 kV, An observation magnification is set so that the number of graphite particles appearing in one field of view is 100 or more and 1000 or less. The obtained SEM image is stored as an image file. In addition, various conditions such as spot diameter, working distance, irradiation current, luminance, and focus are appropriately set so as to make the contour of the graphite particle clear.

### (3) Determination of Aspect Ratio

From the acquired SEM image, 100 graphite particles are randomly selected, and for each of the particles, the longest diameter A of the graphite particle and the longest diameter B in the direction perpendicular to the diameter A are measured to calculate the A/B value. The average value of all the calculated A/B values is calculated to determine the aspect ratio of the graphite particles.

The “amount of substance of the unsaturated cyclic carbonate” is an amount of substance of unsaturated cyclic carbonate contained in the nonaqueous electrolyte of the nonaqueous electrolyte energy storage device, and is not an amount of substance of unsaturated cyclic carbonate contained in the nonaqueous electrolyte used in the manufacture of the nonaqueous electrolyte energy storage device. The nonaqueous electrolyte energy storage device according to one aspect of the present invention is completed through initial charge-discharge, and a part of unsaturated cyclic carbonate contained in the nonaqueous electrolyte used in the manufacture is decomposed during the initial charge-discharge to form a film on the particle surface of the negative active material. For this reason, the amount of substance of the unsaturated cyclic carbonate contained in the nonaqueous electrolyte used in the manufacture and the amount of substance of the unsaturated cyclic carbonate contained in the nonaqueous electrolyte of the nonaqueous electrolyte energy storage device completed through the initial charge-discharge have a certain degree of correlation but do not coincide with each other. Specifically, “the amount of substance of the unsaturated cyclic carbonate with respect to the surface area of the negative active material layer” is measured by the following method.

### (1) Measurement of Amount of Substance of Unsaturated Cyclic Carbonate in Nonaqueous Electrolyte

Mass A of the nonaqueous electrolyte energy storage device is measured. Thereafter, the nonaqueous electrolyte energy storage device is disassembled, and the nonaqueous electrolyte is collected. All components other than the nonaqueous electrolyte are washed with dimethyl carbonate and thoroughly vacuum dried. Mass B of all components other than the nonaqueous electrolyte after vacuum drying is measured. The difference between the mass A and the mass B is defined as mass c of the nonaqueous electrolyte contained in the nonaqueous electrolyte energy storage device. On the other hand, the concentration (% by mass) of the unsaturated cyclic carbonate in the nonaqueous electrolyte is determined by GC-MS analysis using the nonaqueous electrolyte collected during disassembly. Mass D of the unsaturated cyclic carbonate in the nonaqueous electrolyte is calculated from the concentration of the unsaturated cyclic carbonate and the mass C of the nonaqueous electrolyte. By dividing the mass D of the unsaturated cyclic carbonate in the nonaqueous electrolyte by molecular weight of the unsaturated cyclic carbonate, the amount of substance of the unsaturated cyclic carbonate in the nonaqueous electrolyte is determined. The structural formula, molecular weight and concentration of the unsaturated cyclic carbonate can be determined by comparison with a result of GC-MS analysis of a calibration curve sample containing an unsaturated cyclic carbonate having a preliminarily known structural formula and concentration under the same conditions.

### (2) Measurement of Surface Area of Negative Active Material Layer

A negative active material layer in a predetermined range is collected from the negative electrode disassembled, cleaned and vacuum-dried at the time of measuring the amount of substance of the unsaturated cyclic carbonate. The mass of the negative active material layer per unit area is determined by measuring the mass of the collected negative active material layer. Mass E of the negative active material is determined from the mass of the negative active material layer per unit area and an area of the negative active material layer provided on the negative electrode. The “area of the negative active material layer” as used herein is defined as an area of a portion facing the positive active material layer with a separator interposed therebetween. On the other hand, BET specific surface area is measured by a nitrogen adsorption method using a part of the negative electrode not used for determining the mass E of the negative active material. This measurement can be performed by “autosorb iQ” manufactured by Quantachrome Instruments. Five points are extracted from a region of P/P0 of the resulting adsorption isotherm of 0.06 to 0.3, BET plotting is performed, and the BET specific surface area is calculated from y-intercept and slope of the straight line. A product of the BET specific surface area of the negative active material layer and the mass E is the surface area of the negative active material layer.

### (3) Calculation of Amount of Substance of Unsaturated Cyclic Carbonate With Respect to Surface Area of Negative Active Material Layer

By dividing the amount of substance of the unsaturated cyclic carbonate substance in the nonaqueous electrolyte determined in (1) by the surface area of the negative active material layer determined in (2), the amount of substance of the unsaturated cyclic carbonate with respect to the surface area of the negative active material layer is determined.

It is preferable that the solid graphite particle has an average particle size of 2 μm or more and 6 μm or less. By using the solid graphite particle with a relatively small particle size as described above, the negative active material layer is densified, the surface area of the solid graphite particle is increased, and conductivity is increased, whereby the power characteristics after long-term use are further enhanced.

The term “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013). Specifically, the measured value can be obtained by the following method. A laser diffraction type particle size distribution measuring apparatus (“SALD-2200” manufactured by Shimadzu Corporation) is used as a measuring apparatus, and Wing SALD II is used as measurement control software. A scattering measurement mode is adopted, and a wet cell, in which a dispersion liquid with a measurement sample dispersed in a dispersion solvent circulates, is irradiated with a laser beam to obtain a scattered light distribution from the measurement sample. The scattered light distribution is approximated by a log-normal distribution, and a particle size corresponding to an accumulation degree of 50% is defined as an average particle size (D50).

It is preferable that the negative active material contained in the negative active material layer is substantially only the solid graphite particle. As described above, when only the solid graphite particle is substantially used as the negative active material, the advantage of using the solid graphite particle is effectively exhibited, and the power characteristics after long-term use are further enhanced.

The phrase “the negative active material contained in the negative active material layer is substantially only the solid graphite particle” means that the content ratio of the solid graphite particle to the negative active materials contained in the negative active material layer is 99% by mass or more.

It is preferable that the negative active material layer is not subjected to pressing. In a conventional nonaqueous electrolyte energy storage device, it is common to press a negative active material layer in a manufacturing step, for densification, improvement of adhesion to a substrate, and the like. However, when the negative active material layer containing a graphite particle is pressed, the degree of exposure of the edge surface of the graphite particle tends to increase due to cracking of the graphite particle or the like, leading to deterioration of power characteristics after long-term use. Therefore, the negative active material layer is not subjected to pressing, whereby the power characteristics after long-term use can be further enhanced. Further, in the nonaqueous electrolyte energy storage device, a sufficiently high density can be obtained by using the solid graphite particle even without pressing the negative active material layer.

The phrase not subjected to pressing means that a step of applying a pressure (linear pressure) of 10 kgf/mm or more to the negative active material layer by an apparatus intended for applying a pressure to a workpiece, such as a roll press, is not carried out during manufacture. That is, the phrase “not subjected to pressing” also includes a case where a slight pressure is applied to the negative active material layer in other steps such as a step of winding the negative electrode. The phrase “not subjected to pressing” includes a case where a step of applying a pressure (linear pressure) of less than 10 kgf/mm is carried out.

Hereinafter, a nonaqueous electrolyte energy storage device according to an embodiment of the present invention, and other embodiments will be described in detail. The names of the respective constituent members (respective constituent elements) used in the respective embodiments may be different from the names of the respective constituent members (respective constituent elements) used in the background art.

### Nonaqueous Electrolyte Energy Storage Device

A nonaqueous electrolyte energy storage device according to an embodiment of the present invention includes a positive electrode, a negative electrode, and a nonaqueous electrolyte. The positive electrode and the negative electrode usually form an electrode assembly stacked or wound with a separator interposed therebetween. The electrode assembly is housed in a case, and the case is filled with the nonaqueous electrolyte. The nonaqueous electrolyte is interposed between the positive electrode and the negative electrode. A nonaqueous electrolyte secondary battery (hereinafter, also simply referred to as a “secondary battery”) will be described as an example of the nonaqueous electrolyte energy storage device.

### Positive Electrode

The positive electrode has a positive electrode substrate, and a positive active material layer stacked on the positive electrode substrate directly or via an intermediate layer that is another layer.

### Positive Electrode Substrate

The positive electrode substrate is a substrate having conductivity. Having conductivity means that the volume resistivity measured in accordance with JISH-0505 (1975) is 10⁷Ω-cm or less. As the material of the positive electrode substrate, a metal such as aluminum, titanium, tantalum, or stainless steel, or an alloy thereof is used. Among these, an aluminum or aluminum alloy is preferable from the viewpoint of the balance of electric potential resistance, high conductivity, and cost. Examples of the form of the positive electrode substrate include a foil, and a vapor deposition film, and a foil is preferred from the viewpoint; of cost. Therefore, the positive electrode substrate is preferably an aluminum foil or an aluminum alloy foil. Examples of the aluminum or aluminum alloy include A1085 and A3003 specified in JIS-H-4000 (2014).

The average thickness of the positive electrode substrate is preferably 3 μm or more and 50 μm or less, more preferably 5 μm or more and 40 μm or less, still more preferably 8 μm or more and 30 μm or less, and particularly preferably 10 μm or more and 25 μm or less. By setting the average thickness of the positive electrode substrate to the above range, it is possible to increase the energy density per volume of a secondary battery while increasing the strength of the positive electrode substrate. The “average thickness” of the positive electrode substrate refers to a value obtained by dividing the mass of a substrate having a predetermined area by the true density and area of the substrate. The same definition applies when the “average thickness” is used for the negative electrode substrate.

### Intermediate Layer

The intermediate layer is a layer arranged between the positive electrode substrate and the positive active material layer. The intermediate layer contains conductive particles such as carbon particles to reduce contact resistance between the positive electrode substrate and the positive active material layer. The configuration of the intermediate layer is not particularly limited, and includes, for example, a resin binder and a conductive particle (conductive agent). The intermediate layer preferably further contains a crosslinking agent. The intermediate layer may cover a part or the entire surface of the positive electrode substrate.

### Positive Active Material Layer

The positive active material layer includes a positive active material. The positive active material layer contains optional components such as a conductive agent, a binder, a thickener, a filler, or the like as necessary.

The positive active material can be appropriately selected from known positive active materials. As the positive active material for a lithium ion secondary battery, a material capable of storing and releasing lithium ions is usually used. Examples of the positive active material include lithium-transition metal composite oxides having an α-NaFeO₂-type crystal structure, lithium-transition metal oxides having a spinel-type crystal structure, polyanion compounds, chalcogenides, and sulfur. Examples of the lithium transition metal composite oxide having an α-NaFeO₂ type crystal structure include Li[LiₓNi₁₋ₓ]O₂ (0≤x<0.5), Li[LiₓNi_{γ}Co_{1-x-γ}]O₂ (0≤x<γ<0.5, 0<γ<1), Li[LiₓCo₁₋ₓ]O₂ (0≤x<0.5), Li[LiₓNi_{γ}Mn_{1-x-γ}]O₂ (0≤x<γ<0.5, 0<γ<1), Li[LiₓNi_{γ}Mn_{β}Co_{1-x-β}]O₂ (0≤x<0.5, 0<γ, 0<β, 0.5<γ+β<1), and Li[LiₓNi_{γ}Co_{β}Al_{1-x-γ-β}]O₂ (0≤x<0.5, 0<γ, 0<β, 0.5<γ+6<1). Examples of the lithium-transition metal composite oxides having a spinel-type crystal structure include LiₓMn₂O₄ and LiₓNi_{γ}Mn₂. Examples of the polyanion compounds include LiFePO₄, LiMnPO₄, LiNiPO₄, LiCoPO₄, Li₃V₂(PO)₃, Li₂MnSiO₄, and Li₂CoPO₄F. Examples of the chalcogenides include titanium disulfide, molybdenum disulfide, and molybdenum dioxide. A part of atoms or polyanions in these materials may be substituted with atoms or anion species composed of other elements. The surfaces of these materials may be coated with other materials. In the positive active material layer, one of these materials may be used singly, or two or more thereof may be used in mixture.

As the positive active material, a polyanion compound is preferable, and lithium iron phosphate is more preferable. The lithium iron phosphate may be one in which a part of LiFePO₄ is substituted with other atoms or other anion species, in addition to LiFePO₄. When the positive active material is such a compound, progress of performance degradation of the secondary battery due to long-term use largely depends on the negative active material. Therefore, in the secondary battery (nonaqueous electrolyte energy storage device) according to an embodiment of the present invention, when the positive active material is such a compound, the effect of having high power characteristics even after long-term use is particularly remarkable.

The positive active material is usually a particle (powder). The average particle size of the positive active material is preferably 0.1 μm or more and 20 μm or less, for example. By setting the average particle size of the positive active material to be equal to or greater than the lower limit, the positive active material is easily manufactured or handled. By setting the average particle size of the positive active material to be equal to or less than the upper limit, the electron conductivity of the positive active material layer is improved. It is to be noted that in the case of using a composite of the positive active material and another material, the average particle size of the composite is regarded as the average particle size of the positive active material.

A crusher or a classifier is used to obtain a powder having a predetermined particle size. Examples of a crushing method include a method in which a mortar, a ball mill, a sand mill, a vibratory ball mill, a planetary hall mill, a jet mill, a counter jet mill, a whirling airflow type jet mill, or a sieve or the like is used. At the time of crushing, wet type crushing in the presence of water or an organic solvent such as hexane can also be used. As a classification method, a sieve or a wind force classifier is used based on the necessity both in dry manner and in wet manner.

The content of the positive active material in the positive active material layer is preferably 50% by mass or more and 99% by mass or less, more preferably 70% by mass or more and 98% by mass or less, further preferably 80% by mass or more and 95% by mass or less. By setting the content of the positive active material to the above range, it is possible to achieve both high energy density and productivity of the positive active material layer.

The conductive agent is not particularly limited as long as it is a material exhibiting conductivity. Examples of such a conductive agent include carbonaceous materials, metals, and conductive ceramics. Examples of the carbonaceous materials include graphitized carbon, non-graphitized carbon, and graphene-based carbon. Examples of the non-graphitized carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the shape of the conductive agent include a powdery shape and a fibrous shape. As the conductive agent, one of these materials may be used singly or two or more of these materials may be used in mixture. These materials may be composited and used. For example, a material obtained by compositing carbon black with CNT may be used. Among these, carbon black is preferable from the viewpoint of electron conductivity and coatability, and in particular, acetylene black is preferable.

The content of the conductive agent in the positive active material layer is preferably 1% by mass or more and 10% by mass or less, more preferably 3% by mass or more and 9% by mass or less. By setting the content of the conductive agent to the above range, the energy density of the secondary battery can be increased.

Examples of the binder include: thermoplastic resins such as fluororesin (polytetrafluoroethylene (PTFE), polyvinylidene fluoride (PVDF), etc.), polyethylene, polypropylene, polyacryl, and polyimide; elastomers such as an ethylene-propylene-diene rubber (EPDM), sulfonated EPDM, a styrene butadiene rubber (SBR), and a fluororubber; and polysaccharide polymers.

The content of the binder in the positive active material layer is preferably 1% by mass or more and 10% by mass or less, more preferably 2% by mass or more and 9% by mass or less (e.g. 3% mass or more and 6% by mass or less). By setting the content of the binder to the above range, the active material can be stably held.

Examples of the thickener include polysaccharide polymers such as carboxymethylcellulose (CMC) and methylcellulose. When the thickener has a functional group reactive with lithium and the like, the functional group may be deactivated by methylation or the like in advance. When a thickener is used, the ratio of the thickener to the entire positive active material layer can be about 8% by mass or less, and is preferably usually about 5.0% by mass or less (e.g. 1.0% by mass or less). The technique disclosed herein can be preferably carried out in an aspect in which the positive active material layer does not contain a thickener.

The filler is not particularly limited. Examples of the filler include polyolefins such as polypropylene and polyethylene, inorganic oxides such as silicon dioxide, aluminum oxide, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride and barium sulfate, nitrides such as aluminum nitride and silicon nitride, and substances derived from mineral resources, such as talc, montmorillonite, boehmite, zeolite, apatite, kaolin, mullite, spinel, olivine, sericite, bentonite and mica, and artificial products thereof. When a filler is used, the ratio of the filler to the entire positive active material layer can be about 8.0% by mass or less, and is preferably usually about 5.0% by mass or less (e.g, 1.0% by mass or less). The technique disclosed herein can be preferably carried out in an aspect in which the positive active material layer does not contain a filler.

The positive active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Nb, or W as a component other than the positive active material, the conductive agent, the binder, the thickener, and the filler.

The density of the positive active material layer is not particularly limited, and is, for example, preferably 1.0 g/cm³ or more and 3.0 g/cm³ or less, more preferably 1.5 g/cm³ or more and 2.5 g/cm³ or less.

The density of the positive active material layer is a value obtained by dividing the mass (g/cm²) per unit area of the positive active material layer by the average thickness (cm). The average thickness of the positive active material layer is an average value of thicknesses measured at five positions for each of ten positive electrodes cut into 2 cm×2 cm. Also, the thickness of the positive active material layer can be measured using a high-accuracy digimatic micrometer manufactured by Mitutoyo Corporation. The same applies to the density and average thickness of the negative active material layer described later.

The average thickness of the positive active material layer (when the positive active material layer is formed on both surfaces of the positive electrode substrate, the total thickness of both surfaces) is not particularly limited, but for example, the lower limit is preferably 20 μm, more preferably 30 μm, still more preferably 40 μm. Meanwhile, the upper limit of the average thickness of the positive active material layer is, for example, preferably 200 μm, more preferably 120 μm, still more preferably 80 μm, even more preferably 70 μm.

### Negative Electrode

The negative electrode has a negative electrode substrate, and a negative active material layer stacked on the negative electrode substrate directly or via an intermediate layer that is another layer. The configuration of the intermediate layer is not particularly limited, and for example can be selected from the configurations exemplified for the positive electrode.

### Negative Electrode Substrate

The negative electrode substrate is a substrate having conductivity. As the material of the negative electrode substrate, a metal such as copper, nickel, stainless steel, or a nickel-plated steel or an alloy thereof is used, and copper or a copper alloy is preferable. Examples of the form of the negative electrode substrate include a foil, and a vapor deposition film, and a foil is preferred from the viewpoint of cost. That is, the negative electrode substrate is preferably a copper foil. Examples of the copper foil include a rolled copper foil and an electrolytic copper foil.

The average thickness of the negative electrode substrate is preferably 2 μm or more and 35 μm or less, more preferably 3 nm or more and 30 μm or less, still more preferably 4 μm or more and 25 μm or less, particularly preferably 5 μm or more and 20 μm or less. By setting the average thickness of the negative electrode substrate to the above range, it is possible to increase the energy density per volume of a secondary battery while increasing the strength of the negative electrode substrate.

### Negative Active Material Layer

The negative active material layer contains a solid graphite particle with an aspect ratio of 1 or more and 5 or less. The solid graphite particle functions as a negative active material. The negative active material layer contains other negative active material, and optional components such as a binder, a conductive agent, a thickener and a filler as necessary. The optional components such as a binder, a conductive agent, a thickener and a filler can be selected from the materials exemplified for the positive electrode.

The solid graphite particle can be used by appropriately selecting a solid particle from various known graphite particles. Examples of the known graphite particles include a natural graphite particle and an artificial graphite particle. Here, the natural graphite is a generic term for graphite which can be taken from natural minerals, and the artificial graphite is a generic term for artificially produced graphite. Specific examples of the natural graphite particle include scale-like graphite, massive graphite (flake graphite), and earthy graphite. The solid graphite particle may be a spheroidized natural graphite particle obtained by spheroidizing flat scale-like graphite. As the solid graphite particle, a natural graphite particle may be used, or an artificial graphite particle may be used, and an artificial graphite particle is preferable. In general, an artificial graphite particle has a smaller specific surface area and less exposure of an edge surface than a natural graphite particle. Therefore, by using an artificial graphite particle, durability is further enhanced, and the power characteristics after long-term use are further enhanced. In addition, the graphite particle may be a graphite particle, the surface of which is coated (for example, with amorphous carbon coating).

The aspect ratio of the solid graphite particle is 1 or more and 5 or less, preferably 2 or more and 4 or less. By setting the aspect ratio of the solid graphite particle to be within the above range, particularly to be equal to or less than the above upper limit, the solid graphite particle is close to a spherical shape, a highly homogeneous film is formed by the unsaturated cyclic carbonate, and current concentration hardly occurs, so that the power characteristics after long-term use are enhanced. In some aspects, the aspect ratio of the solid graphite particle may be 2.2 or more (e.g. 2.5 or more, e.g. 2.7 or more). In some aspects, the aspect ratio of the solid graphite particle may be 3.5 or less (e.g. 3.0 or less).

The solid graphite particle may be, for example, spherical or non-spherical Specific examples of the non-spherical shape include a massive shape, a spindle shape, a scale-like shape, a plate shape, an elliptical type, and an ovoid shape. Among them, a massive solid graphite particle is preferable. The solid graphite particle may have irregularities on the surface. The solid graphite particle may include a particle in which a plurality of graphite particles is aggregated.

The average particle size of the solid graphite particles may be, for example, 0.1 μm or more and 30 μm or less (typically 0.3 μm or more and 25 μm or less), but is preferably 0.5 μm or more and 15 μm or less, more preferably 1 μm or more and 10 μm or less, still more preferably 2 μm or more and 6 μm or less, and even more preferably 2.5 μm or more and 4 μm or less. By setting the average particle size of the solid graphite particles to the above range, particularly to be equal to or less than the above upper limit, the surface area is increased, and conductivity is increased, so that the power characteristics after long-term use are further enhanced. In addition, by setting the average particle size of the solid graphite particles to be equal to or more than the above lower limit, ease of handling during manufacture and the like can be enhanced. Preferred examples of the solid graphite particle disclosed herein include: one with an average particle size (D50) of 5 μm or less and an aspect ratio of 1 or more and 5 or less; one with an average particle size (D50) of 4.5 μm or less and an aspect ratio of 1.5 or more and 4.5 or less; one with an average particle size (D50) of 4 μm or less and an aspect ratio of 1.8 or more and 4 or less; and one with an average particle size (D50) of 3 μm or less and an aspect ratio of 2 or more and 3.5 or less. By using such a solid graphite particle with an aspect ratio and an average particle size (D50) within a predetermined range, the above-described effect can be more effectively exhibited.

The true density of the solid graphite particle is preferably 2.1 g/cm³ or more. By using the solid graphite particle having such a high true density, the energy density can be increased. Meanwhile, the upper limit of the true density of the solid graphite particles is, for example, 2.5 g/cm³. The true density is measured by a gas volume method with a pycnometer that uses a helium gas. The BET specific surface area of the solid graphite particle is not particularly limited, but is, for example, 3 m²/g or more. By using the solid graphite particle with a large BET specific surface area as described above, the above-described effect can be more effectively exhibited. The BET specific surface area of the solid graphite particle is preferably 3.2 m²/g or more, more preferably 3.5 m²/g or more, still more preferably 3.7 m²/g or more. The upper limit of the BET specific surface area of the solid graphite particle is, for example, 10 m²/g. The BET specific surface area of the solid graphite particle is preferably 8 m²/g or less, more preferably 6 m²/g or less, still more preferably 5 m²/g or less. The BET specific surface area of the solid graphite particle is grasped by pore size distribution measurement by one-point method using nitrogen gas adsorption.

The R value of the solid graphite particles can be generally 0.25 or more (e.g. 0.25 or more and 0.8 or less), and is, for example, 0.28 or more (e.g, 0.28 or more and 0.7 or less), typically 0.3 or more (e.g. 0.3 or more and 0.6 or less. In some aspects, R2 of the solid graphite particles may be 0.5 or less, or 0.4 or less. Here, the “R value” is the ratio of the peak intensity (I_{D1}) of the D band to the peak intensity (I_{G1}) of the G band (I_{D1}/I_{G1}) in the Raman spectrum.

The Raman spectrum is obtained by performing Raman spectrometry under the conditions of a wavelength of 532 nm (YAG laser), a grating of 600 g/mm, and a measurement magnification of 100 times using “HR Revolution” manufactured by HORIBA, Ltd. Specifically, first, Raman spectrometry is performed over the range of 200 cm⁻¹ to 4000 cm⁻¹, and the obtained data is normalized by the maximum intensity (for example, the intensity of the G band) in the measurement range with the minimum value at 4000 cm⁻¹ as a base intensity. Next, using a Lorentz function, fitting is performed on the obtained curve to calculate the intensities of the G band near 1580 cm⁻¹ and the D band near 1350 cm⁻¹, which are defined as “peak intensity of G band (I_{G1})” and “peak intensity of D band (I_{D1})”, respectively, in the Raman spectrum.

A solid graphite particle in a negative active material layer of a negative electrode provided in the secondary battery (nonaqueous electrolyte energy storage device) according to an embodiment of the present invention usually has a film formed on a surface thereof. This film is usually formed by performing initial charge-discharge in a manufacturing process. This film is usually a film derived from the unsaturated cyclic carbonate added to a nonaqueous electrolyte used in manufacture, and may be a film derived from the unsaturated cyclic carbonate and other components.

The negative active material layer may contain other negative active materials other than the solid graphite particle as long as the effect of the present invention is not impaired. Examples of the other negative active materials include carbonaceous materials other than solid graphite particle, metals such as Si and Sn, their oxides, or composites of any of these and carbonaceous materials. Examples of the carbonaceous materials other than solid graphite particle include hollow graphite particle and non-graphitic carbon. The “hollow graphite particle” is a graphite particle other than solid graphite particle. The “non-graphitic carbon” refers to a carbonaceous material in which the average lattice spacing (d₀₀₂) of the (002) plane determined by the X-ray diffraction method before charge-discharge or in the discharged state is 0.34 nm or more and 0.42 mn or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material. The “hardly graphitizable carbon” refers to a carbon material in which the d₀₀₂ is 0.36 nm or more and 0.42 nm or less. The “easily graphitizable carbon” refers to a carbon material in which the d₀₀₂ is 0.34 nm or more and less than 0.36 nm.

The lower limit of the content ratio of the solid graphite particle to all the negative active materials contained in the negative active material layer may be 50% by mass or 70% by mass, but is preferably 90% by mass, more preferably 95% by mass, still more preferably 99% by mass, even more preferably 99.9% by mass. The upper limit of the content ratio of the solid graphite particle to all the negative active materials contained in the negative active material layer may be 100% by mass. As described above, the negative active material contained in the negative active material layer is preferably substantially only the solid graphite particle. When only the solid graphite particle is substantially used as the negative active material, the power characteristics after long-term use are further enhanced.

The content of the solid graphite particle in the negative active material layer is preferably 60% by mass or more and 99% by mass or less, more preferably 80% by mass or more and 98% by mass or less, further preferably 90% by mass or more and 97% by mass or less. In addition, the content of the negative active material in the negative active material layer is preferably 60% by mass or more and 99% by mass or less, more preferably 80% by mass or more and 98% by mass or less, further preferably 90% by mass or more and 97% by mass or less. By setting the contents of the solid graphite particle and the negative active material to the above ranges, the power characteristics after long-term use, the energy density and productivity of the negative active material layer and the like can be further enhanced.

The content of the hinder in the negative active material layer is preferably 1% by mass or more and 10% by mass or less, and more preferably 3% by mass or more and 9% by mass or less. By setting the content of the binder to the above range, the solid graphite particle can be stably held.

When a conductive agent is used in the negative active material layer, the ratio of the conductive agent to the entire negative active material layer can be about 10% by mass or less, and is preferably usually about 8.0% by mass or less (e.g. 3.0% by mass or less). The technique disclosed herein can be preferably carried out in an aspect in which the negative active material layer does not contain a conductive agent.

When a thickener is used in the negative active material layer, the ratio of the thickener to the entire negative active material layer can be about 8% by mass or less, and is preferably usually about 5.0% by mass or less (e.g. 1.0% by mass or less).

When a filler is used in the negative active material layer, the ratio of the filler to the entire negative active material layer can be about 8.0% by mass or less, and is preferably typically about 5.0% by mass or less (e.g. 1.0% by mass or less). The technique disclosed herein can be preferably carried out in an aspect in which the negative active material layer does not contain a filler.

The negative active material layer may contain a typical nonmetal element such as B, N, P, F, Cl, Br, or I, a typical metal element such as Li, Na, Mg, K, Ca, Zn, Ga, Ge, Sn, Sr, and Ba or a transition metal element such as Sc, Ti, V Cr, Mn, Fe, Co, Ni, Cu, Mo, Zr, Ta, Hf, Nb, or W as a component other than the negative active material, the binder, the conductive agent, the thickener, and the filler.

It is preferable that the negative active material layer is disposed in a state of not subjected to pressing directly or via another layer to the negative electrode substrate. In addition, the ratio of surface roughness R₂ of the negative electrode substrate in a region without the negative active material layer stacked to surface roughness R₁ of the negative electrode substrate in a region with the negative active material layer stacked (R₂/R₁) is preferably 0.90 or more and 1.10 or less, more preferably 0.92 or more and 1.05 or less, still more preferably 0.94 or more. In the negative electrode in which the negative active material layer is stacked on the negative electrode substrate, as the negative active material layer is more strongly pressed, the surface roughness R₁ of the region with the negative active material layer stacked in the negative electrode substrate increases, and thus reducing the ratio to the surface roughness R₂ of the region without the negative active material layer stacked (R₂/R₁). In other words, when the negative active material layer is not subjected to pressing, the surface roughness has almost the same value in the region with the negative active material layer disposed and the region without the negative active material layer disposed in the negative electrode substrate (for example, an exposed region of the negative electrode substrate in the case where the negative electrode has an exposed part of the negative electrode substrate). More specifically, the ratio (R₂/R₁) will be brought close to 1. That is, when the ratio (R₂/R₁) is in the above range, it means that a pressure applied to the negative active material layer stacked on the negative electrode substrate is none or small.

As described above, when the negative active material layer is not subjected to pressing or when the ratio (R₂/R1) is in the above range, the exposure of the edge surface in the solid graphite particles is reduced, so that the power characteristics after long-term use can be further enhanced.

The “surface roughness” of the negative electrode substrate means a value obtained by measuring arithmetic mean roughness Ra of a surface (for a region where the negative active material layer and other layers are stacked, a surface after these layers are removed) of the negative electrode substrate with a laser microscope in accordance with JIS-B0601 (2013). Specifically, the measured value can be obtained by the following method, First, in the case where the negative electrode has an exposed part of the negative electrode substrate, the surface roughness of the part is measured in accordance with JIS-B0601 (2013) with the use of a commercially available laser microscope (device name “VK-8510” from KEYENCE CORPORATION), as the surface roughness R₂ of the region without the negative active material layer disposed. In this regard, as measurement conditions, a measurement region (area) is 149 μm×112 μm (16688 μm²), and a measurement pitch is 0.1 μm. Then, the negative active material layer and the other layers are removed from the negative electrode substrate by shaking the negative electrode with the use of an ultrasonic cleaner. The surface roughness R₁ of the region with the negative active material layer stacked is measured by the same method as for the surface roughness of the part where the negative electrode substrate is exposed. It is to be noted that in the case where the negative electrode has no exposed part of the negative electrode substrate (for example, in the case where the entire surface of the negative electrode substrate is covered with the intermediate layer), the surface roughness R₂ of the region without the negative active material layer disposed (for example, the region covered with the intermediate layer, and without the negative active material layer disposed) will be measured by the same method. The shaking with an ultrasonic cleaner used can be performed by shaking while immersing in water for 3 minutes and then in ethanol for 1 minute with the use of a desktop ultrasonic cleaner “2510J-DTH” from Branson Ultrasonics, Emerson Japan, Ltd.

The surface roughness R₂ of the negative electrode substrate in the region without the negative active material layer stacked is, for example, 0.1 μm or more and 1.0 μm, and may be 0.3 μm or more and 3 μm or less.

The density of the negative active material layer is not particularly limited, and for example, the lower limit thereof is preferably 0.8 g/cm³, more preferably 1.0 g/cm³, still more preferably 1.1 g/cm³, even more preferably 1.2 g/cm³ (e.g. 1.3 g/cm³). By setting the density of the negative active material layer to be equal to or more than the above lower limit, the energy density per volume can be increased, and the like. In addition, when a solid graphite particle with a relatively small particle size is used, the negative active material layer can have a high density without pressing the negative active material layer, so that the power characteristics after long-term use can be enhanced while increasing the energy density per volume. Meanwhile, the upper limit of the density of the negative active material layer is preferably 1.8 g/cm³, more preferably 1.6 g/cm³ (e.g. 1.55 g/cm³), still more preferably 1.5 g/cm³ (e.g. 1.45 g/cm³).

The average thickness of the negative active material layer (when the negative active material layer is formed on both surfaces of the negative electrode substrate, the total thickness of both surfaces) is not particularly limited, but for example, the lower limit is preferably 30 μm, more preferably 40 μm, still more preferably 50 μm. Meanwhile, the upper limit of the average thickness of the negative active material layer is, for example, preferably 220 μm, more preferably 200 μm, still more preferably 180 μm. In some aspects, the upper limit of the average thickness of the negative active material layer may be, for example, 150 μm, typically 120 μm (e.g. 100 μm, 80 μm or 60 μm). In the nonaqueous electrolyte energy storage device including the negative active material layer with the above average thickness, the application effect of the present aspect can be more suitably exhibited.

### Separator

The separator can be appropriately selected from known separators. As the separator, for example, a separator composed of only a substrate layer, a separator in which a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, a porous resin film is preferable from the viewpoint of strength, and a nonwoven fabric is preferable from the viewpoint of liquid retaining property of the nonaqueous electrolyte. As the material of the substrate layer of the separator, a polyolefin such as polyethylene or polypropylene is preferable from the viewpoint of a shutdown function, and polyimide, aramid or the like is preferable from the viewpoint of resistance to oxidation and decomposition. As the substrate layer of the separator, a material obtained by combining these resins may be used.

The heat resistant particles included in the heat resistant layer preferably have a mass loss of 5% or less in the case of temperature increase from room temperature to 500° C. under the air atmosphere of 1 atm, and more preferably have a mass loss of 5% or less in the case of temperature increase from room temperature to 800° C. under the air atmosphere of 1 atm. Inorganic compounds can be mentioned as materials whose mass loss is less than or equal to a predetermined value when the materials are heated. Examples of the inorganic compound include: oxides such as iron oxide, silicon oxide, aluminum oxide, titanium dioxide, zirconium oxide, calcium oxide, strontium oxide, barium oxide, magnesium oxide, and aluminosilicate; hydroxides such as magnesium hydroxide, calcium hydroxide, and aluminum hydroxide; nitrides such as aluminum nitride and silicon nitride; carbonates such as calcium carbonate; sulfates such as barium sulfate; hardly soluble ionic crystals such as calcium fluoride, barium fluoride, and barium titanate; covalently bonded crystals such as silicon and diamond; and substances derived from mineral resources, such as talc, montmorillonite, boehmite, zeolite, apatite, kaolin, mullite, spinel, olivine, sericite, bentonite and mica, and artificial products thereof. As the inorganic compound, a simple substance or a complex of these substances may be used alone, or two or more thereof may be mixed and used. Among these inorganic compounds, silicon oxide, aluminum oxide, or aluminosilicate is preferable from the viewpoint of safety of the energy storage device.

A porosity of the separator is preferably 80% by volume or less from the viewpoint of strength, and is preferably 20% by volume or more from the viewpoint of discharge performance. The “porosity” herein is a volume-based value, and means a value measured with a mercury porosimeter.

As the separator, a polymer gel composed of a polymer and a nonaqueous electrolyte may be used. Examples of the polymer include polyacrylonitrile, polyethylene oxide, polypropylene oxide, poly ethyl methacrylate, polyvinyl acetate, polyvinylpyrrolidone, and polyvinylidene fluoride. The use of polymer gel has the effect of suppressing liquid leakage. As the separator, a polymer gel may be used in combination with a porous resin film, a nonwoven fabric, or the like as described above.

### Nonaqueous Electrolyte

The nonaqueous electrolyte contains an unsaturated cyclic carbonate. The nonaqueous electrolyte may be a nonaqueous electrolyte solution further containing other nonaqueous solvent and an electrolyte salt in addition to the unsaturated cyclic carbonate.

The unsaturated cyclic carbonate is a cyclic carbonate having a carbon-carbon unsaturated bond in the molecule, and is a component added as a component for forming a film covering the surface of the solid graphite particle. A part of the unsaturated cyclic carbonate added to the nonaqueous electrolyte used in the manufacture of the nonaqueous electrolyte energy storage device is decomposed in order to form the film during the initial charge-discharge, but the unsaturated cyclic carbonate that was not decomposed was not decomposed in the initial charge-discharge remains in the nonaqueous electrolyte.

The unsaturated cyclic carbonate may be a cyclic carbonate having a carbon-carbon double bond in the molecule. Examples of the unsaturated cyclic carbonate include cyclic carbonates having a carbon-carbon double bond in a cyclic structure, and cyclic carbonates having a carbon-carbon double bond in a portion other than the cyclic structure. The unsaturated cyclic carbonate may be one in which some or all of hydrogen atoms are substituted with other groups or elements.

Examples of the cyclic carbonate having a carbon-carbon double bond in the cyclic structure include vinylene carbonate, fluorovinylene carbonate, ethylvinylene carbonate, fluoromethylvinylene carbonate, ethylvinylene carbonate, propylvinylene carbonate, butylvinylene carbonate, dimethylvinylene carbonate, diethylvinvlene carbonate, dipropylvinylene carbonate, trifluoromethylvinylene carbonate, catechol carbonate, 1-phenylvinylene carbonate, and 1,2-diphenylvinylene carbonate.

Examples of the cyclic carbonate having a carbon-carbon double bond in a portion other than the cyclic structure include vinylethylene carbonate and styrene carbonate.

As the unsaturated cyclic carbonate, a cyclic carbonate having a carbon-carbon double bond in the cyclic structure is preferable, and vinylene carbonate is more preferable.

The concentration of the unsaturated cyclic carbonate (that is, the residual concentration of unsaturated cyclic carbonate that was not decomposed in the initial charge-discharge) in the nonaqueous electrolyte is, for example, preferably 0.1% by mass or more and 5% by mass or less, more preferably 0.2% by mass or more and 3% by mass or less, still more preferably 0.3% by mass or more and 1% by mass or less.

The lower limit of the amount of substance of the unsaturated cyclic carbonate with respect to the surface area of the negative active material layer is 0.03 mmol/m², preferably 0.04 mmol/m², more preferably 0.05 mmol/m² or 0.06 mmol/m² in some cases. By setting the amount of substance of the unsaturated cyclic carbonate with respect to the surface area of the negative active material layer to be equal to or more than the above lower limit, a sufficient film is formed, and the power characteristics after long-term use can be enhanced. On the other hand, the upper limit of the amount of substance of the unsaturated cyclic carbonate with respect to the surface area of the negative active material layer is 0.08 mmol/m², preferably 0.07 mmol/m², more preferably 0.06 mmol/m² or 0.05 mmol/m² in some cases. By setting the amount of substance of the unsaturated cyclic carbonate with respect to the surface area of the negative active material layer to be equal to or less than the upper limit, it is possible to suppress the film formed at the time of initial charge-discharge from becoming too thick, and as a result of improving the power characteristics immediately after initial charge-discharge, the power characteristics are high even after long-term use.

As the other nonaqueous solvent, it is possible to use a known nonaqueous solvent typically used as a nonaqueous solvent of a general nonaqueous electrolyte for an energy storage device. Examples of the other nonaqueous solvent include cyclic carbonate, chain carbonate, ester, ether, amide, sulfone, lactone, and nitrile. The cyclic carbonate as the other non-aqueous solvent does not contain an unsaturated cyclic carbonate.

As the other nonaqueous solvent, it is preferable to use at least one of the cyclic carbonate and the chain carbonate, and it is more preferable to use the cyclic carbonate and the chain carbonate in combination. When the cyclic carbonate and the chain carbonate are used in combination, the volume ratio of the cyclic carbonate to the chain carbonate (cyclic carbonate chain carbonate) is not particularly limited but is preferably from 5:95 to 50:50, for example.

Examples of the cyclic carbonate include ethylene carbonate (EC), propylene carbonate (PC), butylene carbonate (BC), chloroethylene carbonate, fluoroethylene carbonate (FEC), and difluoroethylene carbonate (DFEC).

Examples of the chain carbonate include diethyl carbonate (DEC), dimethyl carbonate (DMC), ethyl methyl carbonate (EMC), and diphenyl carbonate.

As the electrolyte salt, it is possible to use a known electrolyte salt typically used as an electrolyte salt of a general nonaqueous electrolyte for an energy storage device. Examples of the electrolyte salt include a lithium salt, a sodium salt, a potassium salt, a magnesium salt, and an onium salt, and a lithium salt is preferable.

Examples of the lithium salt include inorganic lithium salts such as LiPF₆, LiPO₂F₂, LiBF₄, LiClO₄, and LiN(SO₂F)₂, and lithium salts having a hydrocarbon group in which hydrogen is replaced by fluorine, such as LiSO₃CF₃, LiN(SO₂CF₃)₂, LiN(SO₂C₂F₅)₂, LiN(SO₂CF₃)(SO₂C₄F₉), LiC(SO₂CF₃)₃ and LiC(SO₂C₂F₅)₃. Among these, an inorganic lithium salt is preferable, and LiPF₆ is more preferable.

The lower limit of the content of the electrolyte salt in the nonaqueous electrolyte is preferably 0.1 mol/dm³, more preferably 0.3 mol/dm³, still more preferably 0.5 mol/dm³, and particularly preferably 0.7 mol/dm³. Meanwhile, the upper limit is not particularly limited, but preferably 2.5 mol/dm³, more preferably 2 mol/dm³, and still more preferably 1.5 mol/dm³.

The nonaqueous electrolyte may contain other additives. Examples of the additive include: aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; succinic anhydride, glutaric anhydride, maleic anhydride, citraconic anhydride, glutaconic anhydride, itaconic anhydride, and cyclohexanedicarboxylic anhydride; ethylene sulfite, propylene sulfite, dimethyl sulfite, dimethyl sulfate, ethylene sulfate, sulfolane, dimethyl sulfone, diethyl sulfone, dimethyl sulfoxide, diethyl sulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, perfluorooctane, tristrimethylsilyl borate, tristrimethylsilyl phosphate, and tetrakistrimethylsilyl titanate. These additives may be used singly, or two or more thereof may be used in mixture.

The content of the additive (component other than an unsaturated cyclic carbonate, other nonaqueous solvent and an electrolyte salt) contained in the nonaqueous electrolyte is preferably 0.01% by mass or more and 10% by mass or less, more preferably 0.1% by mass or more and 7% by mass or less, still more preferably 0.2% by mass or more and 5% by mass or less, and particularly preferably 0.3% by mass or more and 3% by mass or less, with respect to a total mass of the nonaqueous electrolyte. By setting the content of the additive to the above range, it is possible to improve capacity retention performance or charge-discharge cycle performance after high-temperature storage, and to further improve safety.

The shape of the nonaqueous electrolyte energy storage device according to the present embodiment is not particularly limited, and examples thereof include cylindrical batteries, pouch film batteries, prismatic batteries, flat batteries, coin batteries and button batteries.

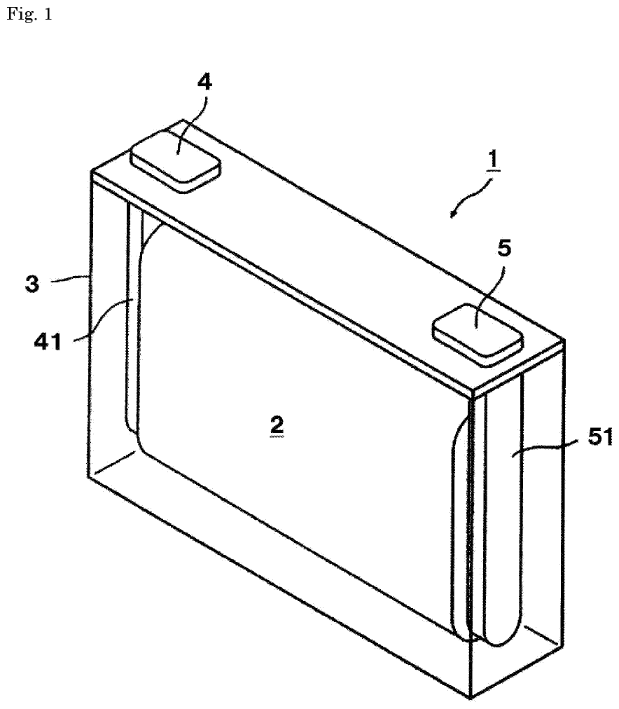

FIG. 1 shows an energy storage device 1 (nonaqueous electrolyte energy storage device) as an example of a prismatic battery. FIG. 1 is a view showing an inside of a case in a perspective manner An electrode assembly 2 having a positive electrode and a negative electrode which are wound with a separator interposed therebetween is housed in a prismatic case 3. The positive electrode is electrically connected to a positive electrode terminal 4 through a positive electrode lead 41. The negative electrode is electrically connected to a negative electrode terminal 5 via a negative electrode lead 51.

### Configuration of Nonaqueous Electrolyte Energy Storage Apparatus

The nonaqueous electrolyte energy storage device of the present embodiment can be mounted as an energy storage apparatus configured assembling a plurality of energy storage devices 1 on a power source for automobiles such as electric vehicles (EV), hybrid vehicles (HEV), and plug-in hybrid vehicles (PHEV), a power source for electronic devices such as personal computers and communication terminals, or a power source for power storage, or the like. In this case, the technique of the present invention may be applied to at least one energy storage device included in the energy storage apparatus. In one preferred aspect, the energy storage apparatus includes the energy storage device according to the above-mentioned embodiment, a detection unit, and a control unit. The detection unit detects a voltage between the positive electrode and the negative electrode of the energy storage device. As the detection unit, a conventionally known voltmeter, voltage sensor or the like can be used. The control unit is electrically connected to the detection unit, and is configured to stop charge of the energy storage device when the voltage detected by the detection unit is equal to or higher than a predetermined value. For example, the control unit can be configured to cut off an electrical connection between a charger and the energy storage device when the voltage becomes equal to or higher than the predetermined value in charging using the charger. The control unit can be composed of a computer and a computer program. In addition, the control unit may be partially or entirely composed of a processor including a semiconductor chip. In the energy storage apparatus according to one embodiment, when the voltage of the energy storage device is the predetermined value, a potential of the positive electrode is 4.2 V (vs. Li/Li⁺) or less. That is, the potential of the positive electrode when charging is stopped is 4.2 V (vs. Li/Li⁺) or less. The potential of the positive electrode when the charge of the energy storage device is stopped by the control unit is preferably 4.1 V (vs. Li/Li⁺) or less, more preferably 4 V (vs. Li/Li⁺) or less. In some aspects, the potential of the positive electrode when the charge of the energy storage device is stopped ley the control unit may be, for example, 3.8 V (vs. Li/Li⁺) or less, or 3.7 V (vs. Li/Li⁺)) or less. In the energy storage apparatus in which the potential of the positive electrode when the charge is stopped is set as described above, the above-described effect can be more effectively exhibited.

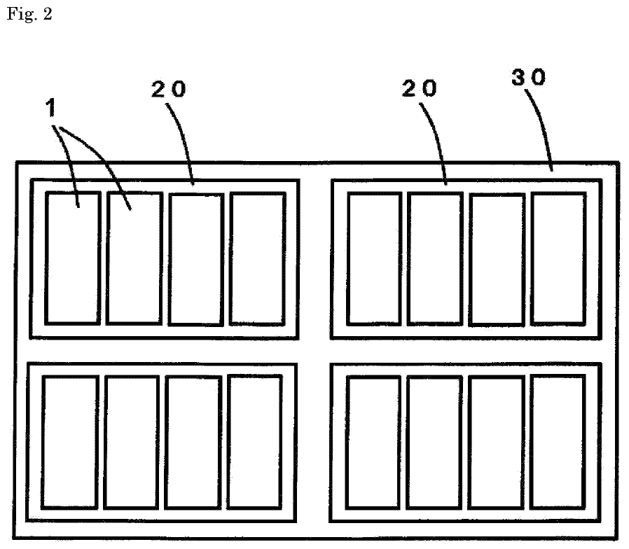

FIG. 2 illustrates an example of an energy storage apparatus 30 formed by assembling energy storage units 20 in each of which two or more electrically connected energy storage devices 1 are assembled. The energy storage apparatus 30 may include a busbar (not illustrated) for electrically connecting two or more energy storage devices 1, a busbar (not illustrated) for electrically connecting two or more energy storage units 20, and the like. The energy storage unit 20 or the energy storage apparatus 30 may include a state monitor (not illustrated) for monitoring the state of one or more energy storage devices.

### Method for Manufacturing Nonaqueous Electrolyte Energy Storage Device

The method for manufacturing the nonaqueous electrolyte energy storage device according to an embodiment of the present invention is not particularly limited, but for example, the following manufacturing method can be adopted.

The manufacturing method includes preparing a negative electrode having a negative active material layer containing a solid graphite particle with an aspect ratio of 1 or more and 5 or less, preparing a nonaqueous electrolyte containing an unsaturated cyclic carbonate, and initially charging and discharging an uncharged and undischarged energy storage device assembled using the negative electrode and the nonaqueous electrolyte.

The step of preparing a negative electrode can be performed by, for example, stacking the negative active material layer along at least one surface of the negative electrode substrate by applying a negative composite to the negative electrode substrate. Specifically, for example, the negative active material layer can be stacked by applying a negative composite to the negative electrode substrate and drying the negative composite.

The negative composite contains the solid graphite particle. The negative composite may be a negative composite paste further containing a dispersion medium in addition to the solid graphite particle, and the optional components constituting the negative active material layer described above. As the dispersion medium, an organic solvent such as N-methylpyrrolidone (NMP) or toluene or water can be used.

It is preferable that the manufacturing method does not include subjecting the negative active material layer to pressing. For example, the manufacturing method may include a step of preparing a negative electrode having an unpressed negative active material layer.

In the step of preparing a nonaqueous electrolyte, for example, a nonaqueous electrolyte can be prepared by mixing components constituting the nonaqueous electrolyte, such as an unsaturated cyclic carbonate, an electrolyte salt and other nonaqueous solvent.

The manufacturing method may further include preparing a positive electrode, stacking the positive electrode and the negative electrode with a separator interposed therebetween to obtain an electrode assembly, housing the electrode assembly in a case, injecting a nonaqueous electrolyte into the case, and the like. Thereafter, an injection port is sealed, thereby obtaining an uncharged and undischarged energy storage device.

The obtained uncharged and undischarged energy storage device is charged and discharged once or a plurality of times as initial charge-discharge. As a result, a part of the unsaturated cyclic carbonate in the nonaqueous electrolyte prepared in the step of preparing a nonaqueous electrolyte is decomposed, and a film is formed on the particle surface of the negative active material. Through such a step, a nonaqueous electrolyte energy storage device in which the amount of substance of the unsaturated cyclic carbonate contained in the nonaqueous electrolyte with respect; to the surface area of the negative active material layer is 0.03 mmol/m² or more and 0.08 mmol/m² or less is obtained.

It is to be noted that the amount of substance of the unsaturated cyclic carbonate contained in the nonaqueous electrolyte with respect to the surface area of the negative active material layer is adjusted by the concentration of the unsaturated cyclic carbonate in the nonaqueous electrolyte prepared in the step of preparing a nonaqueous electrolyte, the amount of the nonaqueous electrolyte, the amount and size (surface area) of the solid graphite particle, and the like.

### Other Embodiments

The nonaqueous electrolyte energy storage device of the present invention is not limited to the above-described embodiment, in the above-described embodiments, an embodiment in which the nonaqueous electrolyte energy storage device is a nonaqueous electrolyte solution secondary battery has been mainly described, but the nonaqueous electrolyte energy storage device may be other nonaqueous electrolyte energy storage device. Examples of the other nonaqueous electrolyte energy storage device include capacitors (electric double layer capacitors and lithium ion capacitors).

### EXAMPLES

Hereinafter, the present invention will be described in more detail with reference to Examples, but the present invention is not limited to the following Examples.

### Example 1

### Fabrication of Negative Electrode

A negative composite paste, containing graphite particle A (bulk solid graphite particle, aspect ratio of 3.0, average particle size of 3.0 μm, BET specific surface area of 3.9 m²/g) as a negative active material, styrene-butadiene rubber (SBR) as a binder and carboxymethyl cellulose (CMC) as a thickener and using water as a dispersion medium, was prepared. The mass ratio of the negative active material, the binder, and the thickener was 96:3.2:0.8. The negative composite paste was applied to both surfaces of a copper foil with an average thickness of 8 μm as a negative electrode substrate and dried to form a negative active material layer, thereby obtaining a negative electrode. The negative active material layer was not subjected to pressing.

The “ratio of surface roughness R₂ of the negative electrode substrate in a region without the negative active material layer stacked to surface roughness R₁ of the negative electrode substrate in a region with the negative active material layer stacked (R₂/R₁)” in the obtained negative electrode was 0.97. The average thickness of the negative active material layer (total of both surfaces) was 54 μm, and the density was 1.37 g/cm³. The area ratio of the graphite particle A excluding voids in the particle relative to the total area of the particle was 99.1%.

### Fabrication of Positive Electrode

An intermediate layer paste containing acetylene black as a conductive agent, hydroxyethyl chitosan as a binder and pyromellitic acid as a crosslinking agent and using N-methylpyrrolidone (NMP) as a dispersion medium, was prepared. The ratio of the conductive agent, the hinder, and the crosslinking agent was adjusted so that the mass ratio in a dried and solidified state was 1:1:1. The prepared intermediate layer paste was applied to both surfaces of an aluminum foil with an average thickness of 15 μm as a positive electrode substrate and dried so that the application amount after drying was 0.05 mg/cm², to form an intermediate layer.

A positive composite paste, containing lithium iron phosphate as the positive active material, polyvinylidene fluoride (PVDF) as a binder and acetylene black as a conductive agent and using n-methylpyrrolidone (NMP) as a dispersion medium, was prepared. The mass ratio of the positive active material, the binder, and the conductive agent was 91:4:5. The positive composite paste was applied to the surface of each intermediate layer formed on both surfaces of the positive electrode substrate, and dried. Thereafter, pressing was performed to form a positive active material layer. Thereby, a positive electrode in which the intermediate layer and the positive active material layer were respectively stacked on both surfaces of the positive electrode substrate was obtained.

The average thickness of the positive active material layer (total of both surfaces) in the obtained positive electrode was 59 μm, and the density was 1.94 g/cm³.

### Preparation of Nonaqueous Electrolyte

Lithium hexafluorophosphate (LiPF₆) as an electrolyte salt was mixed at a concentration of 1.2 mol/dm³ with a nonaqueous solvent obtained by mixing ethylene carbonate, dimethyl carbonate and ethyl methyl carbonate at a volume ratio of 30:35:35. Vinylene carbonate (VC) as an unsaturated cyclic carbonate was added to the mixed solution at a concentration of 1.50% by mass to prepare a nonaqueous electrolyte.

### Assembly of Nonaqueous Electrolyte Energy Storage Device

The positive electrode and the negative electrode, and a polyethylene microporous membrane separator with a thickness of 15 μm were stacked and wound to prepare a wound-type electrode assembly. The wound-type eiectrode assembly was housed in a case. Subsequently, the nonaqueous electrolyte was injected into the case to obtain an uncharged and undischarged energy storage device.

### Initial Charge-Discharge

The obtained uncharged and undischarged energy storage device was subjected to constant-current constant-voltage (CCCV) charging under the conditions of a charge current of 1 C and an end-of-charge voltage of 3.5 V in a thermostatic bath at 25° C. until a charging time reached a total of 3 hours. Then, constant-current (CC) discharging was performed under the conditions of a discharge current of 1 C and an end-of-discharge voltage of 2.0 V. A nonaqueous electrolyte energy storage device of Example 1 was obtained by the initial charge-discharge described above.

The capacity confirmation described later was also performed under the above conditions.

### Examples 2 to 4, Comparative Examples 1 to 10

Each of the nonaqueous electrolyte energy storage devices of Examples 2 to 4 and Comparative Examples 1 to 10 were obtained in the same manner as in Example 1 except that the type of graphite particle as a negative active material, whether pressed or not during formation of the negative active material layer, the average thickness and density of the negative active material layers (total of both surfaces), and the VC concentration of the prepared nonaqueous electrolyte were as shown in Table 1.

The area ratio of the graphite particle B excluding voids in the particle relative to the total area of the particle was 88.8%, and the average particle size was 8.8 μm. In addition, the area ratio of the graphite particle C excluding voids in the particle relative to the total area of the particle was 98.5%, and the average particle size was 10.3 μm.

It is to be noted that two each of the nonaqueous electrolyte energy storage devices for measurement of the amount of substance of the unsaturated cyclic carbonate with respect to the surface area of the negative active material layer and for evaluation of power characteristics after long term use were prepared.

### Measurement of Amount of Substance of Unsaturated Cyclic Carbonate With Respect to Surface Area of Negative Active Material Layer

For the obtained nonaqueous electrolyte energy storage devices for disassembly analysis of Examples and Comparative Examples, the concentration of VC (unsaturated cyclic carbonate) in the nonaqueous electrolyte and the amount of substance of VC (unsaturated cyclic carbonate) with respect to the surface area of the negative active material layer were measured by the method described above. The measurement results are shown in Table 1.

### Evaluation

### Long-Term Charge-Discharge Cycle Test

Each of the obtained nonaqueous electrolyte energy storage devices was charged to SOC 50% in a thermostatic bath at 25° C. (subjected to constant-current constant-voltage (CCCV) charging with a quantity of electricity of 50% of a discharge capacity obtained by the previous capacity confirmation under the conditions of a charge current of 1 C and an end-of-charge voltage of 3.5 V), and then allowed to stand in a thermostatic bath at 45° C. for 4 hours to stabilize the temperature. Thereafter, constant-current (CC) charging was performed under the conditions of a charge current of 8 C and an end-of-charge voltage of 3.5 V, and then constant-current (CC) discharging was performed under the conditions of a discharge current of 8 C and an end-of-discharge voltage of 3.05 V. This charge-discharge cycle was performed for 250 hours. No pause was made after charging and discharging. Thereafter, the nonaqueous electrolyte energy storage device was allowed to stand in a thermostatic bath at 23° C. for 4 hours to stabilize the temperature, and then discharged under the conditions of a discharge current of 1 C and an end-of-discharge voltage of 2.0 V to bring the nonaqueous electrolyte energy storage device into a discharged state. Subsequently, capacity confirmation and power characteristic measurement described later were performed under the same conditions as in the above “initial charge-discharge”.

The above-described 250 hour charge-discharge cycle, capacity confirmation and power characteristic measurement were repeated, and the test was performed until the total charge-discharge cycle time reached 3,500 hours.

### Power Characteristic Measurement

Each of the nonaqueous electrolyte energy storage devices was subjected to constant-current constant-voltage (CCCV) charging with a quantity of electricity of 50% of a discharge capacity obtained by the previous capacity confirmation under the conditions of a charge current of 1 C and an end-of-charge voltage of 3.5 V in a thermostatic bath at 25° C. from the discharged state to be charged to SOC 50%. The nonaqueous electrolyte energy storage device at SOC 50% was subjected to power characteristic measurement under the following conditions.

Constant-current (CC) discharging was performed at a current value of 5 C for 10 seconds, and after a pause of 60 seconds, constant-current (CC) charging was performed at a current value of 0.5 C with the same quantity of electricity as the discharged quantity of electricity, and a pause of 300 seconds was made. Thereafter, tests were conducted at the respective current values under the same conditions except that the discharge current value was changed to 10 C, 15 C, 20 C, and 25 C. Each measured value was plotted with each discharge current value (5 C, 10 C, 15 C, 20 C, 25 C) on a horizontal axis, and a voltage after 1 second from the start of discharge on a vertical axis. Linear approximation was performed by using a least squares method for these plots. The absolute value of the slope of the straight line is defined as a resistance R [Ω] of the nonaqueous electrolyte energy storage device. Based on the calculated resistance H, power P [W] that can be output to the nonaqueous electrolyte energy storage device was calculated by (Equation 1) below and defined as “power characteristic [W]”.

P=Vₘᵢₙ×(V₅₀−Vₘᵢₙ)/R (Equation 1)

Here, Vₘᵢₙ means a lower limit value of a voltage to be used per one nonaqueous electrolyte energy storage device. In all Examples and Comparative Examples, 2.63 V was used for Vₘᵢₙ. In addition, V₅₀ means an open circuit voltage at SOC 50%. For V₅₀, the voltage immediately before 5 C discharge was rounded off to the third decimal place and used as a value up to the second decimal place.

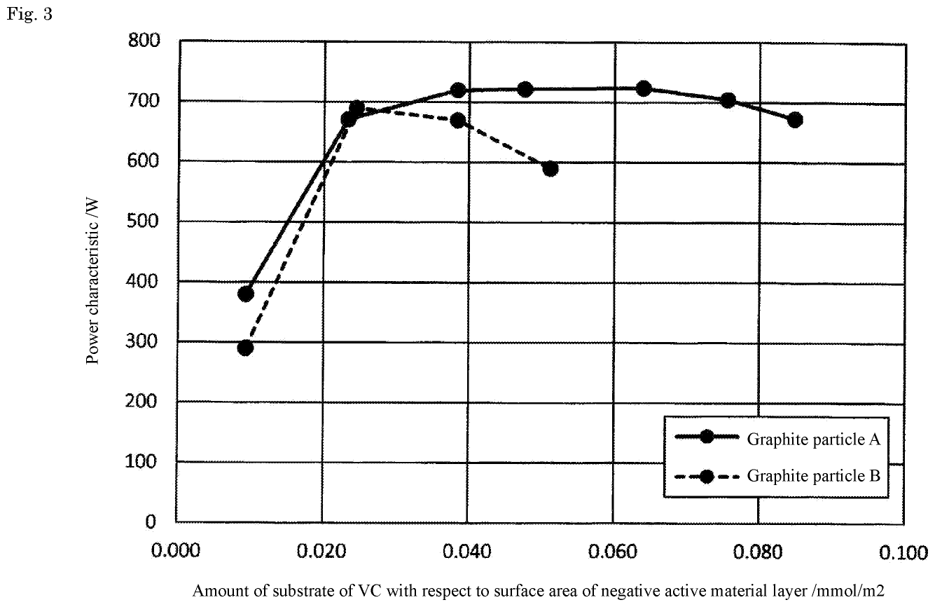

The power characteristic measured after a total charge-discharge cycle time of 3,500 hours are show in Table 1. In addition, the results of Examples 1 to 4 and Comparative Examples 1 to 3 using the graphite particle A (solid graphite particle with an aspect ratio of 3) and Comparative Examples 4 to 7 using the graphite particle B (hollow graphite particle with an aspect ratio of 1.6) are shown in FIG. 3.

TABLE 1

| | Manufacturing conditions, etc. | | | | | | |
|---|---|---|---|---|---|---|---|
| | | | | | | | VC |
| | | | | | | | Concentration |
| | Negative active material | | | Negative active material layer | | | of prepared |
| | (Graphite particle) | | | | Average | | nonaqueous |
| | | | Aspect | | thickness/ | Density/ | electrolyte/ |
| | Type | Shape | ratio | Pressing | μm | cm³ | mass % |
| Example 1 | A | Solid | 3.0 | None | 54 | 1.37 | 1.5 |
| Example 2 | A | Solid | 3.0 | None | 54 | 1.37 | 1.7 |
| Example 3 | A | Solid | 3.0 | None | 54 | 1.37 | 2.0 |
| Example 4 | A | Solid | 3.0 | None | 54 | 1.37 | 2.2 |
| Comparative | A | Solid | 3.0 | None | 54 | 1.37 | 1.0 |
| Example 1 | | | | | | | |
| Comparative | A | Solid | 3.0 | None | 54 | 1.37 | 1.2 |
| Example 2 | | | | | | | |
| Comparative | A | Solid | 3.0 | None | 54 | 1.37 | 2.5 |
| Example 3 | | | | | | | |
| Comparative | B | Hollow | 1.6 | Done | 67 | 1.08 | 1.5 |
| Example 4 | | | | | | | |
| Comparative | B | Hollow | 1.6 | Done | 67 | 1.08 | 2.0 |
| Example 5 | | | | | | | |
| Comparative | B | Hollow | 1.6 | Done | 67 | 1.08 | 2.5 |
| Example 6 | | | | | | | |
| Comparative | B | Hollow | 1.6 | Done | 67 | 1.08 | 3.0 |
| Example 7 | | | | | | | |
| Comparative | C | Solid | 10.0 | Done | 62 | 1.08 | 3.0 |
| Example 8 | | | | | | | |
| Comparative | C | Solid | 10.0 | Done | 62 | 1.08 | 4.4 |
| Example 9 | | | | | | | |
| Comparative | C | Solid | 10.0 | Done | 62 | 1.08 | 8.6 |
| Example 10 | | | | | | | |

| | Nonaqueous electrolyte energy storage device | | |
|---|---|---|---|
| | VC | Amount of substrate | |
| | Concentration | of VC with respect | |
| | of nonaqueous | to surface area of | Power |
| | electrolyte/ | negative active material | characteristic/ |
| | mass % | layer/mmol/m² | W |
| Example 1 | 0.40 | 0.038 | 720 |
| Example 2 | 0.50 | 0.048 | 722 |
| Example 3 | 0.67 | 0.064 | 724 |
| Example 4 | 0.80 | 0.076 | 705 |
| Comparative | 0.10 | 0.009 | 380 |
| Example 1 | | | |
| Comparative | 0.25 | 0.023 | 671 |
| Example 2 | | | |
| Comparative | 0.90 | 0.085 | 673 |
| Example 3 | | | |
| Comparative | 0.15 | 0.009 | 290 |
| Example 4 | | | |
| Comparative | 0.38 | 0.024 | 690 |
| Example 5 | | | |
| Comparative | 0.60 | 0.038 | 670 |
| Example 6 | | | |
| Comparative | 0.80 | 0.051 | 590 |
| Example 7 | | | |
| Comparative | 0.40 | 0.009 | 692 |
| Example 8 | | | |
| Comparative | 0.80 | 0.019 | 578 |
| Example 9 | | | |
| Comparative | 2.00 | 0.047 | 295 |
| Example 10 | | | |

As shown in Table 1, in each of the nonaqueous electrolyte energy storage devices of Examples 1 to 4 using the solid graphite particle (graphite particle A) with a small aspect ratio, in which the amount of substance of VC with respect to the surface area of the negative active material layer is 0.03 mmol/m² or more and 0.08 mmol/m² or less, the power characteristic after the long-term charge-discharge cycle test were high values exceeding 700 W. On the other hand, even when the solid graphite particle (graphite particle A) with a small aspect ratio was used, in each of the nonaqueous electrolyte energy storage devices of Comparative Examples 1 to 3 in which the amount of substance of VC was less than 0.03 mmol/m² or more than 0.08 mmol/m² and each of the nonaqueous electrolyte energy storage devices of Comparative Examples 4 to 10 using the hollow graphite particle (graphite particle B) or the solid graphite particle (graphite particle C) with a large aspect ratio, the power characteristic after the long-term charge-discharge cycle test were 700 W or less. It could be confirmed that a nonaqueous electrolyte energy storage device having high power characteristics even after long-term use was obtained by using the solid graphite particle with a small aspect ratio and setting the amount of substance of the unsaturated cyclic carbonate with respect to the surface area of the negative active material layer to 0.03 mmol/m² or more and 0.08 mmol/m² or less.

In addition, as shown in FIG. 3, in the case of using the solid graphite particle (graphite particle A), the power characteristics were conversely enhanced in the range of the amount of the unsaturated cyclic carbonate (the range where the amount of substance of the unsaturated cyclic carbonate with respect to the surface area of the negative active material layer is 0.03 mmol/m² or more and 0.08 mmol/m² or less) in which the power characteristics were deteriorated in the case of using the hollow graphite particle (graphite particle B). This is considered to be because the thickness and its uniformity of the film formed by the decomposition of the unsaturated cyclic carbonate vary depending on the shape of the graphite particle. That is, the effect that the power characteristics are high even after long-term use is considered to be a specific effect caused by combining a graphite particle having a specific shape and one in which the amount of substance of the unsaturated cyclic carbonate with respect to the surface area of the negative active material layer is in a predetermined range.

### INDUSTRIAL APPLICABILITY

The present invention is suitably used as an energy storage device including a nonaqueous electrolyte solution secondary battery used as a power source for electronic devices such as personal computers and communication terminals, automobiles, and the like.

### DESCRIPTION OF REFERENCE SIGNS

1: energy storage device

2: electrode assembly

3: case

4: positive electrode terminal

41: positive electrode lead

5: negative electrode terminal

51: negative electrode lead

20: energy storage unit

30: energy storage apparatus

1. A nonaqueous electrolyte energy storage device comprising:
a negative electrode including a negative active material layer; and
a nonaqueous electrolyte containing an unsaturated cyclic carbonate, wherein
the negative active material layer contains a solid graphite particle with an aspect ratio of 1 or more and 5 or less, and
an amount of substance of the unsaturated cyclic carbonate with respect to a surface area of the negative active material layer is 0.03 mmol/m² or more and 0.08 mmol/m² or less.

2. The nonaqueous electrolyte energy storage device according to claim 1, wherein the solid graphite particle has an average particle size of 2 μm or more and 6 μm or less.

3. The nonaqueous electrolyte energy storage device according to claim 1, wherein a negative active material contained in the negative active material layer is substantially only the solid graphite particle.

4. The nonaqueous electrolyte energy storage device according to claim 1, wherein the negative active material layer is not subjected to pressing.

5. The nonaqueous electrolyte energy storage device according to claim 1, comprising a positive electrode including a positive active material layer, wherein
the positive active material layer contains a polyanion compound as a positive active material.
